(19) United States
(12) Patent Application Publication
(10) Pub. No.: US 2021/0208948 A1
(43) Pub. Date: Jul. 8, 2021

(54) System and method for operating a service to arrange automatic resource capacity marketplace between Kubernetes clusters.

(71) Applicant: TOMER MENACHEM SAGI, PORTLAND, OR (US)

(72) Inventor: TOMER MENACHEM SAGI, PORTLAND, OR (US)

(21) Appl. No.: 17/142,567

(22) Filed: Jan. 6, 2021

Related U.S. Application Data
(60) Provisional application No. 62/957,754, filed on Jan. 6, 2020.

(51) Int. Cl. G06F 9/50; G06F 9/54; G06Q 30/02; H04L 9/06

(52) U.S. Cl. CPC G06F 9/5072; G06F 9/505; G06F 9/545; G06F 2209/5011; H04L 9/0643; H04L 2209/38; G06Q 30/0206

(57) ABSTRACT

A method and a system for creating a marketplace for compute capacity of Kubernetes clusters. The system facilitates buying and selling capacity offered by capacity sellers and purchased by capacity buyers. The system supports migration of computing workload from the buyer to the seller cluster, running of workload, and migration of the results back to the buyer cluster. The method and system also support payment by capacity buyers to capacity sellers as well as feedback gathering on the buyers and the sellers.

### BACKGROUND

Current computing workload (for example, AI/ML) executes using virtualization, which presents the actual computer hardware (for example, memory and CPU) as an abstract resource available for consumption by the computation. Such virtualization technology has led to the creation of public clouds (e.g., AWS or Azure), which offer hardware resources sold as a unit of time (for example, 1 hour CPU). Virtualization is supported by using virtual machines and, more recently, using containers and container orchestrators (e.g., Kubernetes).

A container is an application packaging and runtime technology that supports running computer programs in isolation from other programs. A container image contains the program and configuration files for the execution of the program. A container engine is a system that understands how to create containers (a running program) from a container image.

A container orchestrator is a program that manages one or more container engines running within a group of computers (aka a cluster). The container orchestrator aggregates each type of resource (e.g., memory and CPU) and decides where to run a given container based on the workload and the desired resources.

One implementation of the container orchestrator is Kubernetes. A Kubernetes cluster comprises several compute nodes (real machines or virtual machines), each running a container engine. Kubernetes contains an API service that accepts descriptions of desired workloads (for example, using Pod API object) and creates containers in order to execute the workload. A scheduler decides where to place the workload based on the workload resource constraints.

Kubernetes clusters can be created on top of public cloud computers or private cloud computers. Each Kubernetes cluster has its maximum resource capacity (which is the sum of all the nodes' capacity) measured, for example, in total CPU and total memory. This capacity is used by the Kubernetes scheduler when deciding on when to start a workload.

However, the Kubernetes cluster does not currently support workload migration (I.e., a scheduler in one Kubernetes cluster cannot place a workload on another Kubernetes cluster), and thus cannot share hardware capacity.

### SUMMARY

The present invention is directed to apparatus and a method for creating a marketplace for selling and buying computational capacity (e.g., memory/CPU) of one or more Kubernetes clusters. The marketplace is comprised of buyers of computing capacity (which require the execution of a workload), sellers of computing capacity (which have a Kubernetes cluster with enough available capacity to execute the buyer's workload) and a capacity matching service that facilitates the capacity purchase, workload execution, billing, and account management.

The buyer of computing capacity represents their capacity request in terms of desired minimum resource on Kubernetes workload objects (e.g., Pod, Job). The requests specify for each workload, how much CPU and memory (and other hardware resources) the workload needs to perform its computational task. The buyer might also specify any other dependency required to execute the workload (e.g., security, storage, etc.).

The sellers of computing capacity use the marketplace to offer the capacity available for sale. The seller can specify different attributes of their capacity, such as the hardware type, the minimum price per resource, the offer duration, etc.

The marketplace service matches the requests for capacity (from the buyers) to the sellers' offers of capacity. Once a match occurs, the system migrates the workload to the seller cluster, where it is executed. Once the workload finish executing, the marketplace manage the payments due to the transaction.

These and other features, aspects, and advantages of the present invention will become better understood with reference to the following drawings, description, and claims.

### BRIEF DESCRIPTION OF THE DRAWING

The accompanying drawings describe reference numerals referring to identical or functionally similar elements throughout the separate views. Together with detailed descriptions below, elements incorporated in and form part of the specification serve to further illustrate embodiments of concepts that include the claimed disclosure and explain various principles and advantages of those embodiments. The methods and systems disclosed herein have been represented appropriately by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a block diagram illustrating components of a single Kubernetes worker computer that can be used by either seller or buyer in implementing a system such as described with FIG. 3.

FIG. 2 is a block diagram illustrating the components of a Kubernetes cluster used by either the buyer or seller to implement a system such as described with FIG. 3.

FIG. 3 is a high level diagram illustrating the components of a marketplace for buying and selling IT computing capacity such as described with other embodiments.

FIG. 4 is a sequence diagram illustrating the interaction between the buyer, the seller and the marketplace when a capacity is sold by the seller to the buyer according to one or more embodiments.

FIG. 5 is a block diagram illustrating the components of a marketplace service component for selling and buying IT computing capacity, such as described with other embodiments.

FIG. 6 is a simplified flow chart illustrating the method of buying capacity from the marketplace and sending some IT workload to execute on the purchased capacity.

FIG. 7 is a simplified flow chart illustrating the method of selling capacity on the marketplace and executing some IT workload on the purchased capacity.

FIG. 8 is a simplified block diagram of a single machine and its components which are used during workload execution, in accordance with various embodiments.

### DETAILED DESCRIPTION

While this technology, susceptible to embodiments in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that similar and analogous elements and/or components, referred to herein may be identified throughout the drawings with corresponding reference characters. It will be further understood that several of the figures are merely schematic representations of the present technology. As such, some of the components may have been distorted from their actual scale for pictorial clarity.

Information technology (IT) organizations need computing capacity to execute information technology workloads (for example, reports, database queries, or training machine learning models). To acquire desired capacity, an IT organization can either purchase the hardware themselves or rent it from a public cloud provider (e.g., AWS or Azure). A public cloud provider usually sells the capacity by a unit of time (e.g., 1 CPU hours for 3 cents).

Moreover, modern application deployment technology relies on containers for packaging the workload binaries and configuration files, and container orchestrators like Kubernetes to execute the containers by scheduling them to one or more worker nodes (composed of the actual hardware resources).

In both cases above, some IT organizations might face underutilization of their capacity (for example, during non-working hours, most of the compute capacity is idle). On the other hand, some other IT organizations face a shortage of computing capacity (e.g., when running end of month reports workload).

The current invention describes a system and subsequent methods for creating a computational capacity marketplace based on Kubernetes clusters. In some embodiments, a capacity buyer issues an order to buy the capacity needed to execute an IT workload. The marketplace may handle the order by selecting a computing capacity seller which offers the necessary capacity to execute the buyer's IT workload. According to some embodiments, the buyer and seller's pairing is performed programmatically and/or automatically, based on parameters such as the price and the hardware needed for execution. Once the match occurs, the system and methods describe a way to execute the IT workload on the provided seller Kubernetes cluster and return the result of the computation to the buyer. The marketplace also provides components for account management of buyers and sellers, user feedback, and billing.

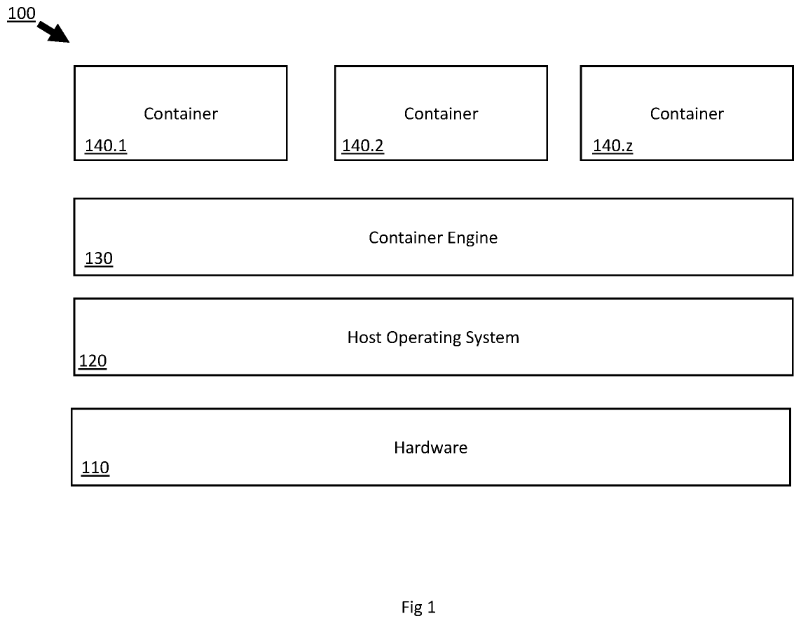

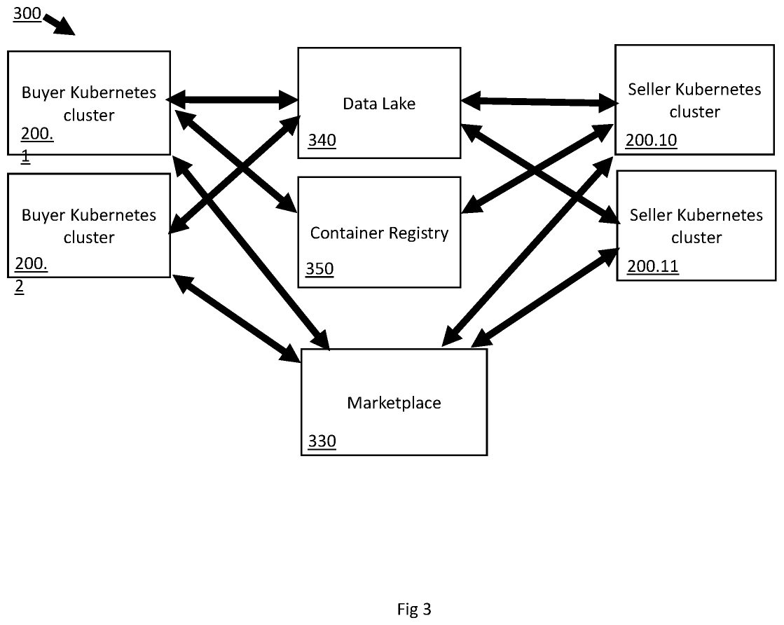

FIG. 1 is a block diagram illustrating components of a single Kubernetes worker computer that can be used by either seller or buyer in implementing a system such as described with FIG. 3.

Environment 100 includes hardware 110, host operating system 120, container engine 130, and containers 140 1-140z. In some embodiments, hardware 110 is described in environment 800. Host operating system 120 runs on hardware 110 and can also be referred to as the host kernel. By way of non-limiting example, host operating system 120 can be at least one of: Linux, Red Hat Atomic Host, CoreOS, Ubuntu Snappy, and the like. Host operating system 120 allows for multiple (instead of just one) isolated user-space instances (e.g., containers 140.1-140z) to run in host operating system 120 (e.g., a single operating system instance).

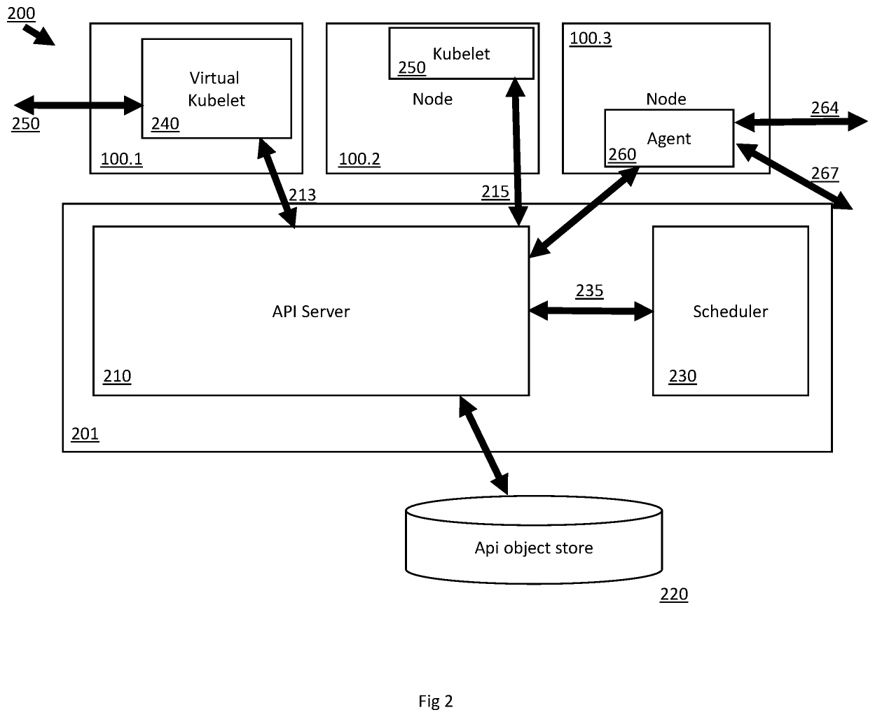

Host operating system 120 can include a container engine 130. Container engine 130 can create and manage containers 140 1-140z, using a (high-level) application programming interface (API). By way of non-limiting example, container engine 130 is at least one of Docker, Rocket (rkt), and the like. For example, container engine 130 may create a container (e.g., one of the containers 140.1-140.z) using an image. An image can be a (read-only) template comprising multiple layers and can be built from a base image (e.g., for host operating system 120) using instructions (e.g., run a command, add a file or directory, create an environment variable, indicate what process (e.g., application or service) to run, etc.). Each image may be identified or referred to by an image type. In some embodiments, images (e.g., different image types) are stored and delivered by a system (e.g., server-side application) referred to as a registry or hub (not shown in FIG. 2).

Container engine 130 can allocate a filesystem of host operating system 120 to the container and add a read-write layer to the image. Container engine 130 can create a network interface that allows the container to communicate with hardware 110 (e.g., talk to localhost). Container engine 130 can set up an Internet Protocol (IP) address for the container (e.g., find and attach an available IP address from a pool). Container engine 130 can launch a process (e.g., application or service) specified by the image (e.g., run an application). Container engine 130 can capture and provide application output for the container (e.g., connect and log standard input, outputs, and errors). The above examples are only for illustrative purposes and are not intended to be limiting.

Containers 140.1-140.z can be created by container engine 130. In some embodiments, containers 140.1-140.z, are each an environment as close as possible to an installation of host operating system 120, but without the need for a separate kernel. For example, containers 140.1-140.z share the same operating system kernel and with host operating system 120. Each container of 140.1-140.z can run as an isolated process in user space on host operating system 120. Shared parts of host operating system 120 can be read-only, while each container of containers 140.1-140.z can have its mount for writing.

FIG. 2 is a block diagram illustrating the components of a Kubernetes cluster used by either capacity buyer or capacity seller to implement a system such as described in FIG. 3.

Environment 200 shows the deployment in a Kubernetes cluster. Environment 200 includes the Master Kubernetes Node 201, comprised of the Kubernetes API server 210, and the Kubernetes scheduler module 230. Environment 200 also shows the storage for the Kubernetes objects 220. By way of non-limiting example, the Kubernetes object store 220 can be etcd. The Kubernetes scheduler 230 performs the workload placement based on the worker nodes' 100.1-100.3, available hardware capacity, and the currently running containers in the cluster. The scheduler 230 communicates the container placement to the API server via communication channel 235.

Environment 200 also includes one or more environments, 100.1-100.3, which are used to run the workload. Each environment 100.1-100.3, is also running a kubelet component, which manages the local container creation based on scheduler 230 decision. When scheduler 230 decides to place container 140.1 on node 100.1, it will communicate with the API server 210 via communication link 235. The API server 210 updates the object storage 220, which notify the kubelet 250 via communication link 215. A kubelet can be a real kubelet 250 or a virtual kubelet 240. A real kubelet 250 on node 100.2, will create a container on its local node. A virtual kubelet 240, can be used to communicate the creation request outside of the cluster (not shown in this figure), for example to the seller cluster.

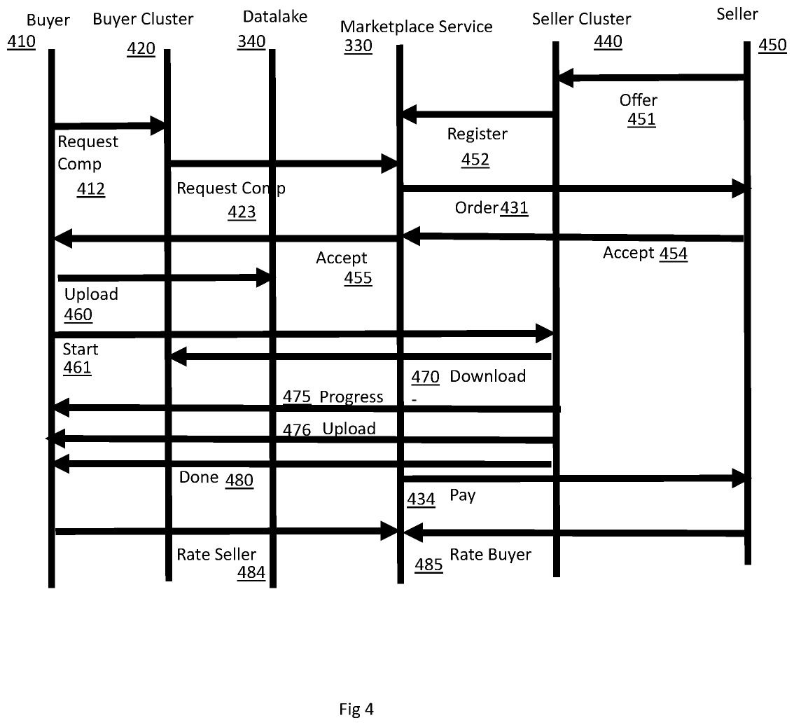

In some embodiments, Environment 200 also contains an agent component 260, which is running on one of the environments 100.1-100.3 as a container 140.1. The agent component 260, communicates with the marketplace via link 264 to order capacity or offer capacity, and executes the marketplace commands when a transaction occurs (See FIG. 4, for the sequence of commands that occur during the capacity purchase transaction). Agent component 260 also communicates with data lake component 340 (not shown in this figure, but shown in FIG. 3) via link 267, to upload or download the artifacts (e.g., data files) needed for workload execution on the seller cluster's capacity.

In some embodiments, to manage and deploy containers, the master node 201 and the worker node 100 receives one or more image types (e.g., named images) from a data storage and content delivery system referred to as a registry (not shown in FIG. 2). By way of non-limiting example, the registry can be the Google Container Registry or Docker Hub container registry.

The API server 210 can maintain (e.g., create and update) the database about Kubernetes object 260. The Kubernetes objects database 260 can include a reliable and authoritative description concerning Kubernetes objects.

FIG. 3 is a high level diagram illustrating the components of a marketplace for buying and selling IT computing capacity such as described with other embodiments.

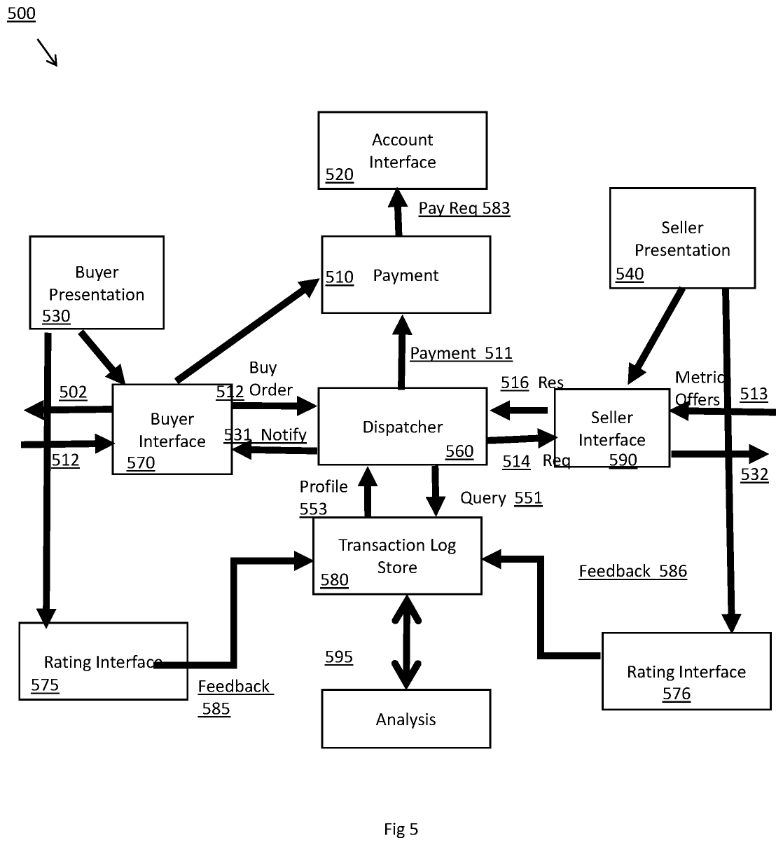

In some embodiments, the capacity buyers are executing their IT workloads on their respective Kubernetes cluster (as described in FIG. 2) 200.1 and 200.2. The capacity sellers are offering the unused hardware resources of their respective Kubernetes clusters 200.10 and 200.11. In some embodiments, the state of the workload is transferred via the data lake 340 and a joint docker registry 350. Both buyer clusters 200.1, 200.2, and seller cluster 200.10 and 200.11 are connected to the market place service 330 (as described in FIG. 5).

In some embodiment the market place service 330 performs the matching of capacity orders from the buyers 200.1 and 200.2 and the capacity offered by the buyers 200.10 and 200.11. The matching process involves finding the best capacity seller to fulfill a capacity purchase order, and dispatching the workload to the seller cluster. In addition, marketplace service 330 provides tracking of the workload computation status while the workload is running on the seller cluster. In some embodiments, marketplace service 330 also support payment processing as well as buyer and seller rating. For detailed explanation of marketplace service 330 see FIG. 5.

In some embodiment, data lake 340 is a common location to store artifacts (e.g., files, configuration) needed by the IT workload migration process. In some embodiments, Data lake 340 can be implemented by cloud storage services like AWS S3. The capacity buyer agent component 260, running in cluster 200.1, upload the workload artifacts to data lake 340 prior to workload execution, and download the results (e.g., machine learning model) after execution. The capacity seller, running in cluster 200.10, downloads the artifacts from data lake 340 before running the buyer workload and uploading the result to data lake 340 after the execution is finished.

In some embodiments, the buyer cluster 200.1 and the seller cluster 200.10 might have direct connection (for example, over a service mesh) and can thus transfer the workload state directly from the seller to the buyer.

In some embodiments, container image registry 350 is a common location to store the workload container or other artifacts that contain the instructions for executing the workload (E.g., web assembly). The capacity buyer agent 260 will upload the image to the image registry 350 before starting the execution on the seller cluster 200.10. The capacity seller agent 260 on the seller cluster 210.1, will download the container image before execution.

FIG. 4 is a sequence diagram illustrating the interaction between the buyer, the seller and the marketplace when a capacity is sold by the seller and purchased by the buyer according to one or more embodiments.

In an embodiment, the capacity buyer 410 (also referred to as a “buyer”) can request to purchase capacity from the marketplace in order to execute some workload. A capacity marketplace (also referred to as a “marketplace”) (FIG. 3, 330) locates an available capacity seller 450 (also referred to as ‘seller’) from a pool of possible sellers to execute workload and return the computation result.

Based on some embodiments, the capacity seller 450 first registers with marketplace 330 by instructing the agent 260 on the seller Kubernetes cluster 440 to offer the available capacity for sale. The agent 260 registers with the marketplace via command 452.

According to some embodiments, the buyer 410 creates regular Kubernetes workload objects (for example, a Pod or a Job) to describe the hardware capacity needed to execute the workload. As described in FIG. 2, the buyer Kubernetes cluster 200 may include network capabilities (e.g., network interface). The network functionality enables the buyer agent 260 in cluster 420 to transmit buy order 423 to marketplace 330, and communicate further with the marketplace 330. The buy order 423 may also include identification information that identifies buyer 410 to either the marketplace 330 or to the seller 450. The identification information includes, for example, a name, account number and rating,

According to an embodiment, the marketplace 330 processes the request 423 by selecting a candidate sellers who can execute the workload. The marketplace 330 can use identification information in the purchase order 423 to identify an account or profile of the buyer. The buyer's account or profile may include or identify (i) funds for payment for workload execution, (ii) rating information that identifies a reputation or class of buyers 410. Other information that may optionally be associated or maintained with the buyer account/profile includes, for example, preferences of the buyer 410 (e.g. type of hardware the buyer prefers), the rating of the buyer 410 (which may be provided by a seller that have previously interacted with), and historical information such as previous sellers that have executed workload from the buyer 410. Such preferences, rating information, historical information, and other profile information can be used to select sellers 450 for the buyer 410 at a given instance. For any given workload, the marketplace may first attempt to locate a seller that the buyer has previously used (and perhaps provided a good rating).

As an alternative or addition, some or all of the account/profile information may be stored with the Buyer 410, and communicated as part of the Buyer's request.

The marketplace 330 uses information in the buyer buy order 423 to select candidate seller 450. To arrange workload execution to the buyer, an embodiment provides that the marketplace 330 implements a pairing process upon receipt of the buy order 423. The marketplace 330 performs the pairing process by (i) using one or more criteria to select a first seller; (ii) sending an buy order 431 to the first Seller 450 and giving the first Seller 450 a short duration to accept the invitation; (iii) if the first seller 450 declines or fails to accept the buy order 431, selecting a second seller respondent using the one or more criteria; (iv) sending the buy order 431 to the second Seller, and giving the second Seller a short duration to accept. The pairing process may be repeated (n times) until a seller 450 communicates back an acceptance 454 to the buy order 431.

As an alternative to a single pairing process, another embodiment provides for selecting sellers by contacting a set of two or more sellers at once, based on criteria such as described above. The particular resource provider that ultimately is selected may correspond to, for example, the first seller 450 in the set to respond and accept the invitation.

Either as part of the buy order 431 or in a follow on communication (following acceptance 454 of the buy order), the marketplace 330 may specify, to the selected seller 450, information about the buyer 410 that includes: (i) the reputation of the buyer 410 (e.g. the user's feedback as provided by other sellers), (ii) the expected fee of the workload execution for that buyer 410 (which may include determining and communicating the buyer resource requirements), The buyer 410 identification information may also be communicated to the seller 450.

Once seller 450 accepted the buy order. It would reserve the capacity at seller cluster 440 and communicate the acceptance to the market place 454. The market place will communicate the acceptance to the buyer via 455. Before execution, buyer 410 will upload the workload artifacts to the data lake 340.

Once the seller 450 starts executing the workload of buyer 410, the agent 260 running inside the seller cluster 440 will download 470 the workload artifacts from data lake 340 and fetch the workload container image or executable (for example, web assembly) from the container registry 350. Once execution starts on the seller cluster 440, will send a series of progress communications 475 to the buyer 410. The progress communications 475 may be generated automatically. The progress communications 475 are transmitted to the seller 410 using network communications. The progress communications 475 may be communicated directly from the seller Kubernetes cluster 440 to the buyer 410, or via the marketplace 330.

According to an embodiment, once seller 440 starts executing workload request from buyer 410, the seller cluster 440 will be used to perform actual resource consumption monitoring functions. The resource consumption monitoring functions enable calculation of the fee that the buyer will have to pay once the workload finishes execution. In an embodiment, the fee determination is based on the resource consumption and/or the time that the buyer 410 workloads was running. The fee determination may also be determined based on a formula or factor that is specific to a particular seller.

According to an embodiment, once the workload 423 is completed executing on the seller cluster 440, the seller agent component 260 running inside the seller cluster 440 will upload the workload result artifacts 476 to the data lake 340 and notify the buyer cluster 420.

In an embodiment, payment is automatic. The marketplace 330 may store or associate an online fund account with the buyer 410. Likewise, seller 450 has an associated account for receiving funds. Once the workload execution is complete, the marketplace 330 will trigger the fund transfer 434. In one embodiment, the funds are transferred from the buyer's account to an account of the marketplace, which then transfers funds to compensate the seller that executed the workload. The distribution of the funds from the buyer 410 may be distributed to the marketplace 330 and a seller 450. The fee transferred from the marketplace 330 to the seller 450 is based on the fee charged to the buyer 410, but may include reductions for use of the marketplace 330. Various payment schemes may be used to compensate the seller 450, such as paying the seller 450 a percentage of the fee or repaying the seller 450 based on multiple parameters that include quality of service, the desirability of capacity, or even hourly.

After the buy order 432 was executed, an embodiment enables both parties to provide feedback about the other. The buyer 410 may provide a rating or feedback 484 to marketplace service 330, to rate, for example, the buyer's experience with the seller. Likewise, the seller can provide a rating or feedback 485 for the buyer 410. The marketplace 330 may associate profiles or accounts with each of the buyer 410 and seller 450, and the rating/feedbacks 485, 484 which may affect the overall rating of the buyer/seller. Thus, the reputation of the buyer 410 or the seller 450 may be influenced by the feedback provided by the other party.

FIG. 5 is a block diagram illustrating the components of a marketplace for selling and buying IT computing capacity, such as described with other embodiments.

In an embodiment, a Kubernetes based capacity marketplace service (e.g., service 330 of (FIG. 3) is implemented on a server (or servers) 500 to arrange IT workload execution for the buyer by pairing hardware capacity seller to capacity buyers. Server 500 may include buyer interface 570, dispatcher 560, account interface 520, and seller interface 590. The buyer interface 570 may be used to handle buyer communications 502, while seller interface 590 is used to manage seller communications 532. The overall service provided on server 500 includes a dispatcher 520, which pairs a seller 410 hardware capacity with a buyer 450 in response to a capacity buy order. The buyer interface 570 and the seller interface 590 also includes tracking components that monitor the workload execution when the workload request is initiated and when the workload is executing on the seller cluster. A presentation component 530, 540 may be provided to generate a graphical user interface for each seller 410 and the buyer 450 before and after the execution. Payment component 510 may be included to handle the automatic payment for the capacity usage by the buyer. These components are described in greater detail below.

### Scheduling, Seller Selection, and Execution

According to embodiments, workload dispatching component 560 implements a selection process that results in a capacity seller cluster 440 being paired to a capacity buyer cluster to execute an IT workload on the seller Kubernetes cluster. On server 500, buyer interface 510 receives the capacity buy order 512 from a given buyer and uses the dispatcher 560 to select a seller 450 for workload specified in 512.

The dispatch component 560 responds to the buy order 512 from the buyer. In responding, the dispatch component 560 may identify relevant parameters, such as the buyer cluster 440 location and profile information about the buyer (e.g., rating, preferences, etc.). The dispatch component 560 may also obtain profile information 553 from the profile database 580. More specifically, as mentioned in some embodiments, server 500 (as part of service 330, FIG. 3) maintains profile information about each service participant. The profile information may be maintained in a profile store 580. Examples of information that may be maintained in the profile store 580 include overall rating/feedback of either party, commentary feedback (such as complaints), name or identity information, credit card information, logs of transactions

Thus, the profile information 553 may be stored in a database or similar data structure. The dispatch component 560 may query 551 the database for information about the buyer, based on the identity identified from the request 512 or other buyer communication 502.

In selecting the seller for a given buy order, dispatch 560 includes information to identify the workload request 514 communicated to the one or more sellers. As discussed previously, multiple requests 514 may be used to progressively select a seller respondent for the buyer, using criteria that includes (i) proximity of the seller cluster 440 to the buyer cluster 420, (ii) rating or class association of the seller 410 and the buyer 450, (iii) buyer 450 preference for a particular seller, hardware class, or another characteristic of the seller or hardware; and (iv) alternative business logic (e.g., a bidding process for the capacity).

In one embodiment, dispatch component 560 sends out multiple buy order requests 514 to multiple sellers in response to buy order 512 communicated via buyer interface 510 (which may receive the buyer communication 502). The requests 514 may be sent in parallel (e.g., concurrently), or in series (sent to one seller, who can then accept or not, then sent to another seller). Each of the initially selected sellers is selected based on parameters such as rating, preference, etc. The seller selected to handle the workload may communicate response 516 via the seller interface 590 (which receives the seller communication 532). Dispatch 560 may then communicate (i) a notification 531 that informs the buyer of the seller selection (including optionally, information about the seller, such as identification and rating);

According to embodiments, once the workload is executing , metrics data 513 is obtained from the seller cluster 440 via the respective seller interfaces 590. A workload tracking component within the seller interface 590 uses the seller cluster 440 metrics to track the workload execution progress. Server 500 implements presentation component 540, 530 for the seller and the buyer. The respective buyer and seller interfaces 570, 590 communicate the workload execution progress to the presentation component 530, 540 for output to the buyer 410 and the seller 450

### Payment

The server 500 includes logic for facilitating payment between buyer(s) 410 and the relevant seller 450 for capacity rental. According to some embodiments, payment is performed automatically, or substantially automatically, in response to the workload's completion. Still, some embodiments provide that the completion of the workload execution can be detected automatically, based on, for example, the status data 513 coming from the seller cluster 440.

As an alternative or addition, some embodiments provide that one or both parties can signify that the execution has been completed with some action, such as providing input via the user interface (for example, using the seller presentation 540 or the buyer presentation 530).

The payment component 510 may receive payment parameters 511 from the dispatcher. The payment parameters 511 may include (i) the start time of the execution, (ii) the end time of the execution, (iii) the resource consumed during execution. Other parameters may also be used, including parameters on predicted or actual market demand, resource availability, time of day, seller rating, and type of hardware.

The payment component 510 may implement one or more algorithms to determine the fee for the used capacity, based on the payment parameters 511 and other parameters or conditions (e.g., market demand, time of day, etc.). Additional descriptions of how payment algorithms can be implemented are described with FIG. 4 and FIG. 5.

Once the workload execution fee is determined, the payment component 510 may communicate payment request 583 to account interface 520. The payment request 583 identifies the amount of the used capacity, the buyer to provide the amount, and the seller that is to be credited for the fare.

In one implementation, the account interface 520 may be used to process and transfer funds from an online account of the buyer to an online account (provided by the server 500). Accordingly, account interface 520 can interfere with online transactional accounts on behalf of either the seller or the buyer. As an alternative, the server 500 may maintain credit card information for buyers and use it to pay the seller.

### Feedback

Some embodiments enable the participants of the capacity marketplace service to provide feedback about one another based on their respective experiences. As mentioned elsewhere, one embodiment provides that each participant can provide feedback that includes a rating or other metrics.

A rating interface 575, 576 may be provided for each buyer and the seller. The rating interface 575 of the buyer 410 enables the buyer 410 to record feedback 585 about a seller 450. Likewise, the rating interface 576 enables the seller 450 to record feedback 586 about the buyer . Each participant's rating information may be recorded as part of that user's profile information and thus stored in the profile store 580.

In some embodiments, the rating interface 575, 576 is provided in part as a web form that the buyer 410 or the seller 450 can interact with to record information about the other participant in the transaction. Still, further, the rating interface may be presented to the user upon completion of the workload.

Once entered, the rating information can have a variety of uses. For example, The marketplace service 330 may prioritize (or emphasize) sellers' selection with good ratings. For example, the workload request 514 may first be sent to sellers with the highest ratings, then sellers with middle tier ratings. Still, some embodiments provide the user with the ability to reject the seller based on, for example, the seller's rating information.

### Log and Data Usage

Still, further, embodiments enable collecting and disseminating data that can promote or facilitate execution services for both seller and workload buyers. A marketplace service 330 may collect and utilize information determined from buyers and sellers for a variety of purposes.

Other types of information that may be collected, disseminated, or otherwise used include (i) popular workload parameters (e.g., machine learning frameworks used in most of the workloads), (ii) popular container images, (iii) estimated execution times for a given workload. Thus, the collection and dissemination/use of this information may be collected to provide additional services or to enhance buyer user experience and workload sellers in providing service.

Information about the various workloads transacted through the service is recorded for a given duration of time. The recorded information is stored in a log 580. The information may be recorded from, for example, dispatch 560, the buyer tracker inside buyer interface 570 and seller tracker inside seller interface 590 (record workload start time, duration), and/or the payment component 580 (record fee paid etc.).

From the recorded information, various kinds of analysis can be performed. An analysis component 595 may analyze information from log 580 to identify information for sellers of the service and direct users who may research based on information recorded by the service. The analysis component 595 may provide output to users on, for example, a website.

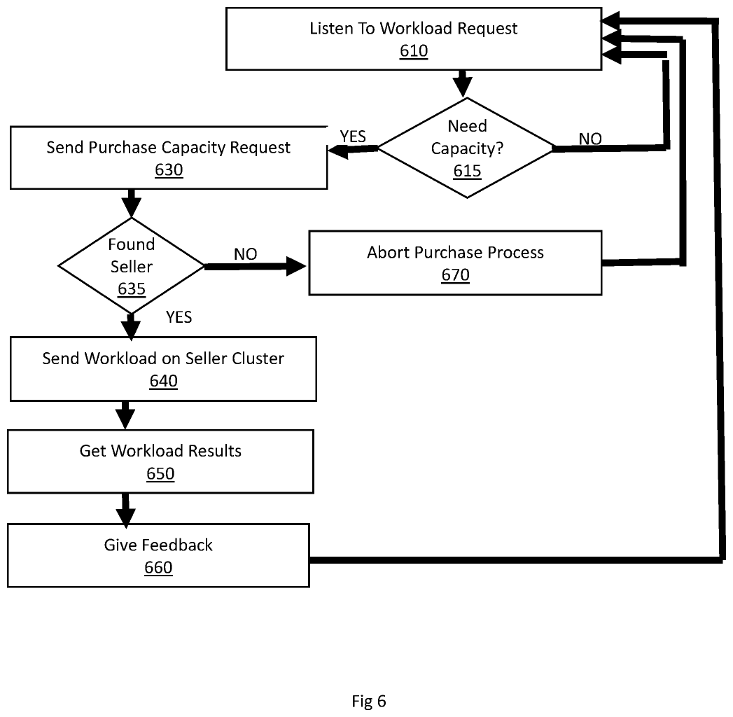

FIG. 6 is a flowchart illustrating a method employed by the capacity buyer agent 260 of buying capacity from the marketplace 330, according to one embodiment.

Referring to FIG. 2, the agent 260, connect to the API server 210, and listen for resource pressures or capacity order request. In some embodiments, capacity order requests are indicated manually by adding labels to Kubernetes objects inside the seller cluster (for example, labeling a pod). In some other embodiments, resource pressures might be detected automatically by watching out of memory errors of currently executing workloads (in the form of Kubernetes Pods).

Once the buyer agent determined the need to buy capacity from the marketplace services 615, the buyer agent will create the buy order 630. The buy order includes the seller ID and the different types of resources and the amount and the time needed. For example, the order might include 2 GPUs for one hour. The agent will use the buyer cluster's network interface to transmit the request to the marketplace on link 512.

The agent will wait for the marketplace 330 to find a seller to fulfill the order. If a marketplace finds a seller, the agent will start the process of executing the workload 640. Otherwise, the agent will abort and will start the process again 670. In some embodiment, the marketplace can return a list of sellers and their prices. In this case, the buyer agent can use different criteria to select a seller.

Once the seller is selected, the buyer agent will notify the marketplace 330, and will start the workload migration process to the seller cluster 440. The buyer engine will upload the workload artifacts into the data lake (as seen in FIG. 3, 380), and will create a workload object and assign it to the virtual kubelet (FIG. 2, 240). At this point, the workload is executing on the seller cluster, and the buyer agent is waiting for the result. During execution, the seller agent sends status updates 513 to the buyer agent via the market place 330.

Once the work is complete, the buyer agent will get notified 531 by the marketplace 330. At this point, the agent will download 650 the workload result artifacts from the data lake 340. In some embodiments, the results of the execution might be transferred via direct communication from the seller cluster or by direct communication from the marketplace.

In some embodiments, Once the buyer agent completes the downloading of the resulting artifacts, it would give feedback 660 about the transaction to the market place. Feedback can be automatic based on some quality measures or manual (given by the cluster operator).

After Giving the feedback, the agent return to the beginning of the process 610. Also not that the above method apply to a single workload request. An buyer agent can handle multiple on going workload requests.

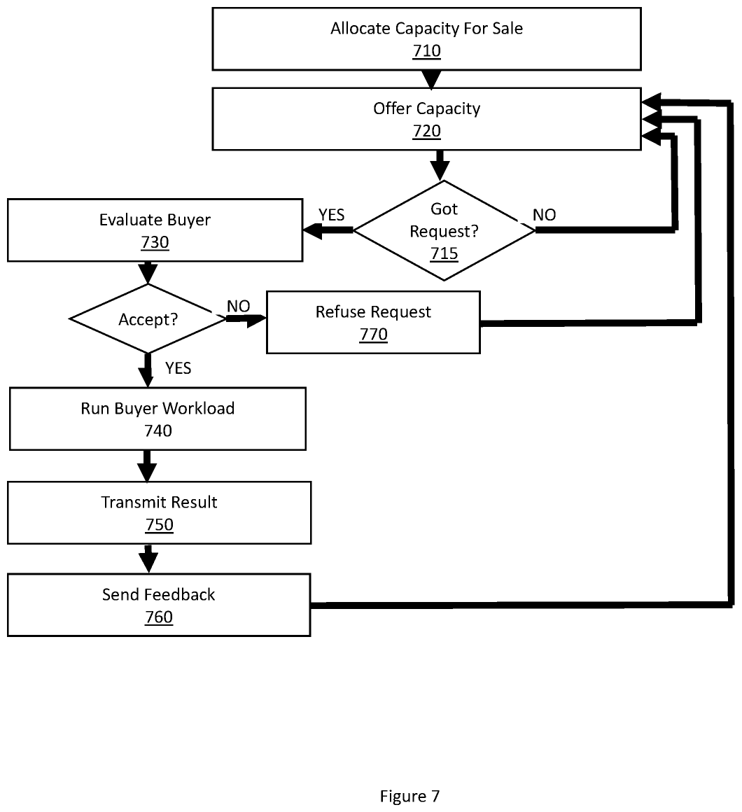

FIG. 7 is a flowchart illustrating a method employed by the capacity sever agent 260 of offering capacity for sale to the marketplace and executing the buyer IT workload according to one embodiment. The method may include different and/or additional steps, or the steps may be in different orders.

Referring to FIG. 2, the seller agent 260 connects to the API server 210 and listens for capacity orders from the market place 330. In some embodiments, To participate in the marketplace 330, the seller agent computes the available capacity for sale and the minimum sale price for each hardware type. In some other embodiment, the capacity for sale can be decided manually by the seller cluster operator or automatically by the agent. It will be communicated to the agent via Kubernetes object (for example, a config map).

Once the agent reserved the available capacity 710, the agent will offer 720 the capacity to the marketplace 330. The agent contacts the marketplace via a network connection and connects to the marketplace service (FIG. 5, 513).

When the seller receives a buy order from the marketplace 715, the seller will evaluate the request based on different criteria. In some embodiment, the seller will evaluate the buyer based on buyer rating, buyer priority, buyer offered resource price, etc. If the seller cannot accept the order 740, the seller agent 260 will send a refusal 770 to the marketplace 330, and continue to watch for incoming orders. Otherwise, the seller agent will send approval of the order. If the marketplace service selects the seller for this order, it would send a start request to the seller agent. The seller will download the order artifacts from the data lake (FIG. 3, 340) and start a workload on the seller cluster (for example, by creating a Pod object or a Job object) 740.

Once the workload is completed, the seller will transmit the execution results to the market place 750. In some embodiments, the seller will transmit the start of the order, the duration of executing the order, and the total price.

The seller agent will also transmit the rating for the buyer 760. The rating can be created automatically (for example, by checking the workload logs, or monitoring information, or manually, as given by the seller cluster operator.

At the end of executing a workload, the seller will return to listening for a new order. Note that the method described in FIG. 7, can run in parallel in response to multiple buy orders.

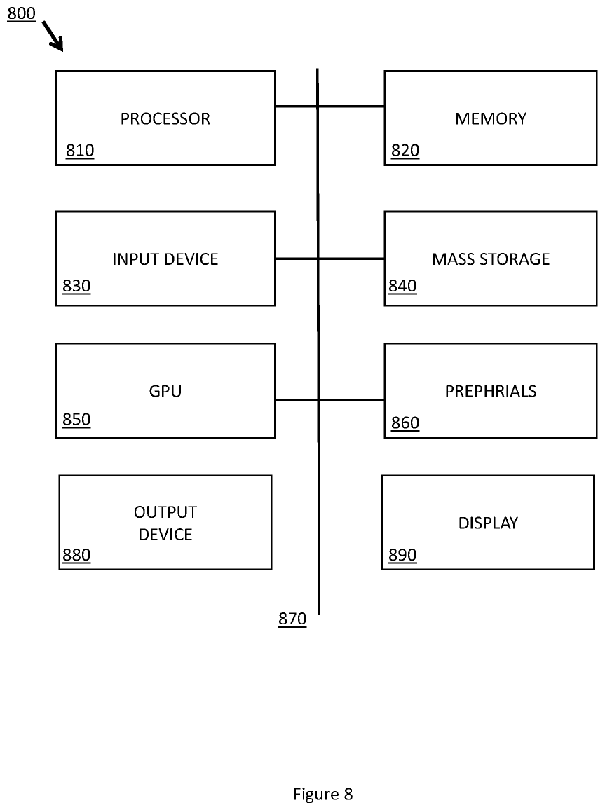

FIG. 8 illustrates an exemplary computer system 800 that may be used to implement some embodiments of the present invention. The computer system 800 in FIG. 8 may be implemented in the likes of computing systems, networks, servers, or combinations thereof. The computer system 800 in FIG. 8 includes one or more processor unit(s) 810 and main memory 820. Main memory 820 stores, in part, instructions, and data for execution by processor unit(s) 810. Main memory 820 stores the executable code when in operation, in this example. The computer system 800 in FIG. 6 further includes a mass data storage 840, output devices 880, user input devices 830, a graphics display system 890, a graphical processing unit 850, and peripheral device(s) 860.

The components shown in FIG. 8 are depicted as being connected via a single bus 870. The components may be connected through one or more data transport means. Processor unit(s) 810 and main memory 820 are connected via a local microprocessor bus, and the mass data storage 840, peripheral device(s) 860, graphical processing unit 850, and graphics display system 890 are connected via one or more input/output (I/O) buses.

Computer program code for carrying out operations for aspects of the present technology may be written in any combination of one or more programming languages, including an object-oriented programming language such as Java, Python or Go or the likes of conventional procedural programming languages, such as the “C” programming language. The program code may execute entirely on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means and functional elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to ordinary skill in the art without departing from the scope and spirit of the invention. Exemplary embodiments were chosen and described in order to best explain the principles of the present technology and its practical application, to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of order indicated in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description but is not intended to be exhaustive or limited to the invention in the form disclosed. Many modifications and variations will be apparent to individuals of ordinary skill in the art without departing from the scope and spirit of the invention. Exemplary embodiments were chosen and described in order to best explain the principles of the present technology and its practical application and to enable others of ordinary skill in the art to understand the invention for various embodiments with various modifications as are suited to the particular use contemplated.

1. A system comprising: at least one processor; and a memory coupled to the at least one processor, the memory comprising computer executable instructions that, when executed by the at least one processor, performs a method for buying and selling computing capacity between Kubernetes clusters, the method comprising:
Advertising available capacity from one or more sellers.
Responding to capacity purchase orders initiated by capacity buyers by selecting a capacity seller from a pool of sellers
Migrating the workload from the buyer Kubernetes cluster and into the seller Kubernetes cluster.
Executing the workload using the purchased capacity within the seller Kubernetes cluster.
Tracking the workload execution at the seller Kubernetes cluster and reporting the progress to the seller and the buyer.
Determining the fee for the capacity used.
Migrating the result of the workload execution back to the buyer.
Transferring the payment to the seller and/or marketplace account.
Enabling the seller/buyer to provide a feedback to affect a service reputation of the buyer/seller upon completing the computation.

2. The system from claim 1, wherein the workload migration is performed using a virtual kubelet inside the buyer Kubernetes cluster. The workload is assigned as a Kubernetes pod or job to the virtual kubelet, and the kubelet connects to the marketplace or to the seller Kubernetes cluster.

3. The system from claim 1 wherein the workload migration is performed by uploading the workload artifacts (data and configuration) to a shared data lake (for example, cloud object storage), and downloading the workload artifacts from the data lake seller cluster.

4. The system from claim 1, wherein the capacity seller is selected based on its reputation

5. The system from claim 1, where the capacity is priced dynamically based on minimum price demanded by the capacity sellers and a maximum price offered by the capacity buyers.

6. The system from claim 1, where the system stores a transaction log of each event in the system and performs further analysis on the history of transaction to create reports or provide analytic information for capacity buyers or sellers.

7. The system from claim 1, where the buyer workload is stored as a web assembly and is executed in a web assembly sandbox inside the seller cluster.

8. The system from claim 1, where the buyer workload is stored inside the container image, is downloaded for a shared image registry executed as a Rod or a Job inside the seller Kubernetes cluster.

9. The system from claim 1, where the payments are performed using cryptocurrency (e.g. bitcoin), and the transactions are recorded using blockchain.

10. A method for buying and selling computing capacity between Kubernetes clusters, the method comprising:
Advertising available capacity from one or more sellers.
Responding to capacity purchase orders initiated by capacity buyers by selecting a capacity seller from the sellers pool.
Migrating the workload from the buyer Kubernetes cluster and into the seller Kubernetes cluster.
Executing the workload using the purchased capacity within the seller Kubernetes cluster.
Tracking the workload execution at the seller Kubernetes cluster and reporting the progress to the seller and the buyer
Determining the fee for the capacity used,
Migrating the result of the workload execution back to the buyer cluster.
Transferring the payment to the seller and/or marketplace account.
Enabling the seller to provide a feedback to affect a service reputation of the buyer upon completing the computation.

11. The method from claim 10, wherein the workload migration is performed using a virtual kubelet inside the buyer Kubernetes cluster. The workload is assigned as a Kubernetes pod or job to the virtual kubelet, and the kubelet connects to the marketplace or to the seller Kubernetes cluster.

12. The method from claim 10 wherein the workload migration is performed by uploading the workload artifacts (data and configuration) to a shared data lake (for example, cloud object storage), and downloading the workload artifacts from the data lake seller cluster.

13. The method from claim 10, wherein the capacity seller is selected based on its reputation

14. The method from claim 10, where the capacity is priced dynamically based on minimum price demanded by the capacity sellers and a maximum price offered by the capacity buyers.

15. The method from claim 10, where the system stores a transaction log of each event in the system and performs further analysis on the history of transaction to create reports or provide analytic information for capacity buyers or sellers.

16. The method from claim 10, where the buyer workload is stored as a web assembly and is executed in a web assembly sandbox inside the seller cluster.

17. The method from claim 10, where the buyer workload is stored inside the container image, is downloaded for a shared image registry executed as a Pod or a Job inside the seller Kubernetes cluster.

18. The method from claim 10, where the payments are performed using cryptocurrency (e.g. bitcoin), and the transactions are recorded using blockchain.
